(19) United States
(12) Patent Application Publication
(10) Pub. No.: US 2015/0131022 A1
(43) Pub. Date: May 14, 2015

(54) MULTIPLE DISPLAY MONITOR

(71) Applicant: SHENZHEN CHINA STAR OPTOELECTRONICS TECHNOLOGY CO. LTD., Shenzhen, Guangdong (CN)

(72) Inventor: Yanxue Zhang, Shenzhen (CN)

(73) Assignee: SHENZHEN CHINA STAR OPTOELECTRONICS TECHNOLOGY CO. LTD., Shenzhen, Guangdong (CN)

(21) Appl. No.: 14/235,450

(22) PCT Filed: Nov. 18, 2013
(86) PCT No.: PCT/CN2013/087310

§ 371 Date: Jan. 27, 2014

(30) Foreign Application Priority Data
Nov. 13, 2013 (CN) 201310565662.9

(51) Int. Cl. F21V 8/00; G02F 1/1335; G02F 1/1333

(52) U.S. Cl. CPC G02B 6/0078; G02F 1/133308; G02F 1/133615; G02B 6/0033
USPC 349/58

(57) ABSTRACT

The invention discloses a multiple display monitor. The multiple display monitor comprises a plurality of liquid crystal display panels that face different directions; the plurality of liquid crystal display panels surround to constitute an accommodating space for accommodating a backlight source device configured to provide a backlight to the plurality of liquid crystal display panels, the backlight source device comprises a plurality of illuminating apparatus corresponding to the liquid crystal display panels one by one in order to provide the backlight to corresponding liquid crystal display panels. A plurality of illuminator is employed to provide light for multiple displays facing different direction. Therefore, each display can transmit or reflect enough light so that each display can display well. Further, all of the displays are connected with each other in such a manner that the structure strength and stability of the multiple display monitor can be improved.

### FIELD OF THE INVENTION

The present invention relates to a monitor, and more particularly to a multiple monitor.

### BACKGROUND OF THE INVENTION

As the development of the monitor, the LCD display monitor has been one of the important developing trends in the flat display field. The LCD comprises two indium-tin oxide glasses and liquid crystal received between the two indium-tin oxide glasses. The LCD displays can be constructed in such manner that the liquid crystal in two indium-tin oxide glasses is activated by an electrical field generated between two indium-tin oxide glasses. However, since the liquid crystal cannot emit light, an external backlight source is employed to make the LCD displays display by means of transmitting and reflecting light emitted from the backlight source.

At present, multiple monitors should be employed to display messages in some public places (such as basketball stadium, music hall, supermarket or the like). In such case, the multiple monitors working at the same time would cause a large waste of energy.

Accordingly, a multiple display monitor is urgent to be provided at present. The multiple display monitor can work by a common energy source, which can save the energy. However, a drawback to the use of the multiple display monitor is that there is only one illuminator in the common backlight source and the light emitted from the common backlight source that is transmitted and reflected by the multiple display monitor is limited. Therefore, the multiple display monitor displays poorly.

### SUMMARY OF THE INVENTION

Aiming at the drawback in the prior art as above-mentioned, a multiple display monitor is proposed in the present disclosure, which can display well.

A multiple display monitor is provided in this disclosure. In one aspect, the multiple display monitor comprises a plurality of liquid crystal display panels that face different directions; the plurality of liquid crystal display panels surround to constitute an accommodating space for accommodating a backlight source device configured to provide a backlight to the plurality of liquid crystal display panels, the backlight source device comprises a plurality of illuminating apparatus corresponding to the liquid crystal display panels one by one in order to provide the backlight to corresponding liquid crystal display panels.

In one embodiment, the backlight source device comprises a plurality of illuminator and a first mounting plate; all of the illuminators are mounted on the first mounting plate and arranged to be the plurality of illuminating apparatus.

Yet in the embodiment, the backlight source device further comprises a second mounting plate; the first mounting plate and the second mounting plate are arranged in parallel with each other; each illuminator is of strip shape and vertically connected between the first mounting plate and second mounting plate.

Yet in the embodiment, the multiple display monitor further comprises a plurality of mounting parts for receiving the liquid crystal display panels one by one; the plurality of liquid crystal display panels are connected head-to-end sequentially through the corresponding mounting parts to form the accommodating space.

Yet in the embodiment, each mounting part comprises a bottom wall and a plurality of side walls that are vertically connected with the edges of the bottom wall; the bottom wall and the plurality of side walls together form an accommodating groove for mounting the liquid crystal display panels.

Yet in the embodiment, each liquid crystal display panel comprises a substrate, a PCB and a plurality of COFs that are connected between the substrate and the PCB; the mounting part further comprises a plurality of first arms of strip shape that are spaced from each other; all of the first arms are arranged in the accommodating groove in horizontal direction and divide the accommodating groove into a first mounting groove for receiving the substrate, a second mounting groove for receiving the PCB and a plurality of third mounting grooves for receiving the plurality of COFs.

Yet in the embodiment, the bottom wall of the mounting part is made of polymeric methyl methacrylate or polycarbonate material.

In another embodiment, the multiple display monitor comprises a plurality of first fasteners, each two adjacent liquid crystal display panels are connected with each other through the first fastener; the plurality of liquid crystal display panels are connected with each other through the plurality of first fasteners to form the accommodating space.

Yet in another embodiment, the first fastener comprises a first side plate and a second side plate vertically connected with the first side plate; a second receiving slot is defined on the outer surface of the first side plate along the length of the first side plate; the second receiving slot is also defined on the outer surface of the second side plate along length of the second side plate; the second side plate is configured for receiving the liquid crystal display panels.

Yet in another embodiment, the multiple display monitor further comprises a plurality of optical films each corresponding to a liquid crystal display panel; each optical film is located on one side of the liquid crystal display panel that is adjacent to the backlight source device.

Yet in another embodiment, a first receiving slot is defined along the length of the first side wall in the central of the first side plate; the first receiving slot is also defined along the length of the second side wall in the central of the second side plate; and the first receiving slot is configured for receiving the optical films.

Yet in another embodiment, the multiple display monitor further comprises a plurality of second fasteners; each liquid crystal display panel is further connected with the backlight source device permanently through at least one of the second fasteners.

Yet in another embodiment, the second fastener comprises a first bending portion of a strip shape and a second portion of a strip shape; the first bending portion and the second bending portion are formed by bending a strip plate; the first bending part is vertically connected to the second bending part.

When implementing the disclosure, the following advantages can be achieved:

In this disclosure, a plurality of illuminator is employed to provide light for multiple displays facing different direction. Therefore, each display can transmit or reflect enough light so that each display can display well.

Further, all of the displays are connected with each other in such a manner that the structure strength and stability of the multiple display monitor can be improved.

### BRIEF DESCRIPTION OF THE DRAWINGS

The present invention can be further illustrated by reading the example with references made to the accompanying drawings, in which:

FIG. 1 is a exploded view of a multiple display device according to the first embodiment of the disclosure;

FIG. 2 is a structural view of a mounting part as shown in FIG. 1;

FIG. 3 is a assembled view of a mounting part and a liquid crystal display panel as shown in FIG. 1;

FIG. 4 is a three-dimensional structural view of a backlight source device as shown in FIG. 1;

FIG. 5 is a exploded view of a multiple display device according to the second embodiment of the disclosure;

FIG. 6 is a three-dimensional structural view of a first fastener as shown in FIG. 5;

FIG. 7 is a three-dimensional structural view of a second fastener as shown in FIG. 6.

### DETAILED DESCRIPTION OF THE PREFERRED EMBODIMENTS

A multiple display monitor can be used in basketball stadium, music hall or the like that requires multiple displays to display messages. The multiple display monitor in this disclosure works by a common energy source. In such case, it is possible to save the energy. The multiple display monitor can display well and has higher structure strength and stability.

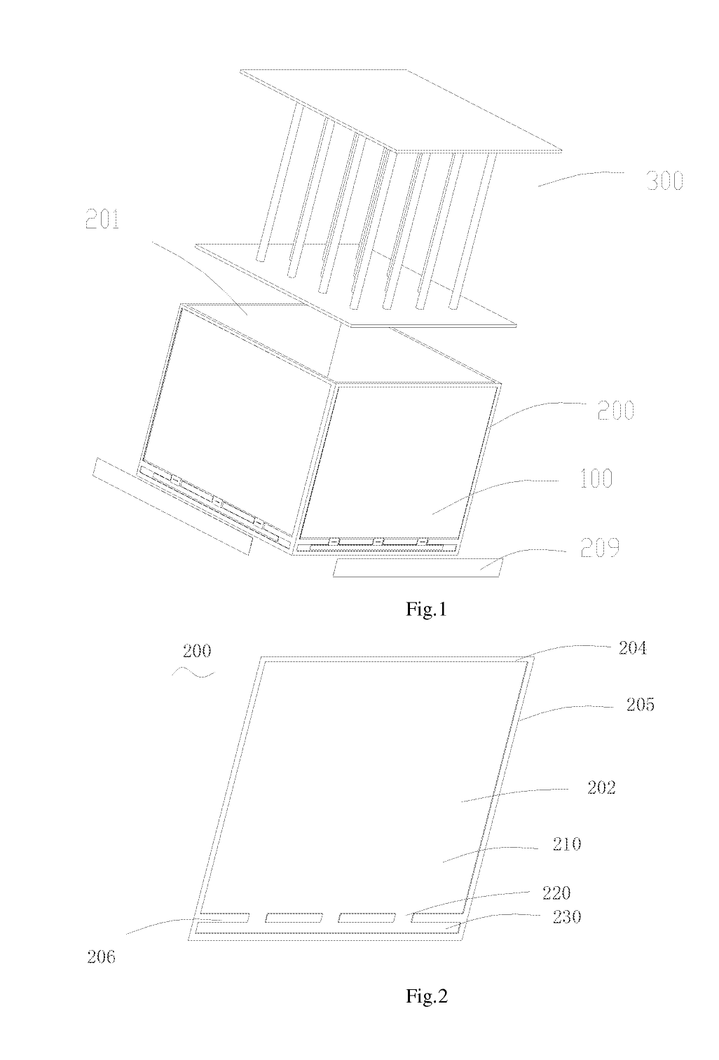

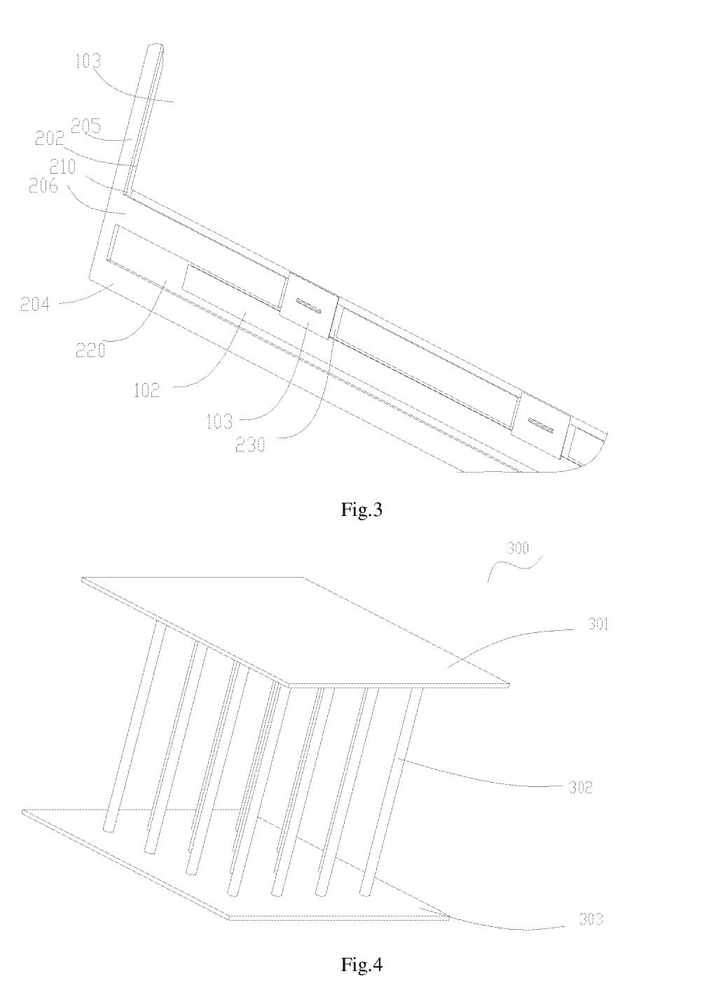

As shown in FIG. 1 to FIG. 4, the multiple display monitor according to the embodiment comprises a plurality of liquid crystal display panels 100 facing different directions. The plurality of liquid crystal display panels 100 surround to form an accommodating space 201 for accommodating a backlight source device 300. The backlight source device 300 is configured to provide light for all of the liquid crystal display panels 100, which comprises a plurality of illuminating apparatus (not numbered) corresponding to the liquid crystal display panels 100 one by one for providing a backlight.

In specific, the backlight source device 300 comprises a first mounting plate 301, a second mounting plate 303 and a plurality of illuminator 302. The illuminator 302 may be a backlight source of strip shape that can illuminate radially. The first mounting plate 301 and the second mounting plate 303 are arranged in parallel with each other. Each illuminator is vertically connected between the first mounting plate and second mounting plate. In such case, the structure strength of the backlight source device can be improved. In other embodiment, the backlight source device 300 may not include such first mounting plate 301, and only the second mounting plate 303 is arranged for mounting the illuminators 302.

In order to make the liquid crystal display panels 100 facing different directions obtain the same amount of light, the plurality of the illuminator 302 are arranged on the second mounting plate to form multiple illuminating apparatuses. The multiple illuminating apparatuses are corresponding to the liquid crystal display panels 100 one by one, which are arranged in parallel with each other. The distance between the illuminating apparatuses and the respective liquid crystal display panel 100 is equal to each other. Each illuminating apparatus has the same number of illuminator 302 so that each liquid crystal display panel 100 can obtain the same amount of the light and can display well while the backlight source device 300 is working.

In the embodiment, the multiple display monitor further comprises a plurality of mounting parts 200. The liquid crystal display panels 100 are received in the mounting parts 200 one by one. All of the liquid crystal display panels 100 are connected head-to-end sequentially through the corresponding mounting parts to form the accommodating space 201. The liquid crystal display panels 100 are connected in such a manner that can improve the connecting strength and structure strength of the multiple display monitor.

In specific, in the embodiment, the cross section of each mounting part 200 is of rectangle shape. The mounting part 200 comprises a bottom wall 202 and a plurality of sidewalls extending vertically from all of edges of the bottom wall 202 in a direction that is remote from the edge of the bottom wall 202. All of the sidewalls are connected with the edges of the bottom wall 202 to form an accommodating groove (not numbered) for receiving each liquid crystal display panel 100. In such case, the liquid crystal display panel 100 can be embedded into the accommodating groove and be detachably mounted in the accommodating groove. The cross section of the accommodating groove is of rectangle shape. All of the sidewalls can be divided into a pair of horizontal sidewall 204 and a pair of vertical sidewall 205.

The liquid crystal display panel 100 in the prior art comprises a substrate 101, a PCB 102 and a plurality of COF 103 connected between the substrate 101 and the PCB 102. All of the COFS 103 are spaced from each other. Due to the complicate outer outline of the liquid crystal display panel 100, the accommodating groove should be shaped to match the outer outline of the liquid crystal display panel 100 to make the liquid crystal display panel 100 received stably. Therefore, the mounting part 200 is provided with a plurality of first arm 206 of strip shape. All of the first arms 206 are aligned with each other to form a straight line and spaced from each other. The distance between each two adjacent first arms 206 is slightly bigger than the width of each COF 103. All of the first arms 206 are received in the accommodating groove along the horizontal direction. All of the first arms 206 and the pair of the horizontal sidewalls 204 are arranged in parallel with each other, which also connected between the pair of the vertical sidewall 205. The inner surface of each first arm 206 is adhered onto the bottom wall 202. Such first arms 206 can divide the accommodating groove into a first mounting groove 210 for receiving the substrate 101, a second mounting groove 220 for receiving the PCB 102 and a plurality of third mounting grooves 230 for receiving the COFs 103. The top horizontal sidewall 204, a pair of vertical sidewall 205 and the upper end of the first arms 206 are connected with each other in order to form the first accommodating groove 210. Correspondingly, the bottom horizontal sidewall 204, a pair of vertical sidewall 205 and the lower end of the first arms 206 are connected with each other in order to form the second accommodating groove 220. The space between each two adjacent first arms 206 can be served as the third accommodating groove 230. The distance between each two adjacent third accommodating grooves 230 is equal to the length of the first arm 206.

In order to prevent the PCB 102 of the liquid crystal display panel 100 from being polluted or wetted, the mounting part 200 is provided with a covering plate 209. The covering plate 209 covers the second accommodating groove 220 to avoid the PCB 102 received in the second accommodating groove 220 exposing out.

In order to make the mounting part 200 simple in structure and reduction in assembling time, the bottom wall 202 and a plurality of side walls can be extruded integrally as one piece. Preferably, the bottom wall 202, a plurality of sidewalls and first arms 206 are extruded integrally as one piece.

An optical film should be arranged on one side of the liquid crystal display panel 100 that is closed to the backlight source device 300 to diffuse the light emitted from the backlight source device 300 to form a surface light source so that each liquid crystal display panel 100 can obtain an even surface light source. The optical film comprises a diffusing film, a light guide plate or the like. In this embodiment, the bottom wall 202 and a plurality of sidewalls are made of polymeric methyl methacrylate or polycarbonate material. In such case, the bottom wall 202 also can be used as the optical film, which can reduce the assembling time and make the multiple display monitor simple in structure.

Take an example to explain the multiple display monitor according to the first embodiment.

In the first embodiment, the multiple display monitor comprises four liquid crystal display panels 100. Each liquid crystal display panel 100 is received in one accommodating groove of the mounting part 200. The four liquid crystal display panels 100 are connected to each other head-to-end sequentially through four mounting parts 200 to form the accommodating space 201. The cross section of the accommodating space 201 is of square shape. The backlight source device 300 is received in the accommodating space 201. The first mounting plate 301 and second mounting plate 303 both are of square shape. A plurality of illuminator 302 are arranged sequentially to form four illuminating apparatuses. Each illuminating apparatus and each liquid crystal display panel 100 are arranged in parallel with each other. The four illuminating apparatuses are arranged to form a cube structure, which is shaped to match the structure formed by the four liquid crystal display panels 100. Each two adjacent vertical sidewalls 205 of each two adjacent mounting parts 200 can be connected together by gluing, welding or the like, or the four mounting parts 200 can be formed integrally as one piece to form a frame. In other embodiments, the multiple display monitor can comprises three, five or more liquid crystal display panels 100.

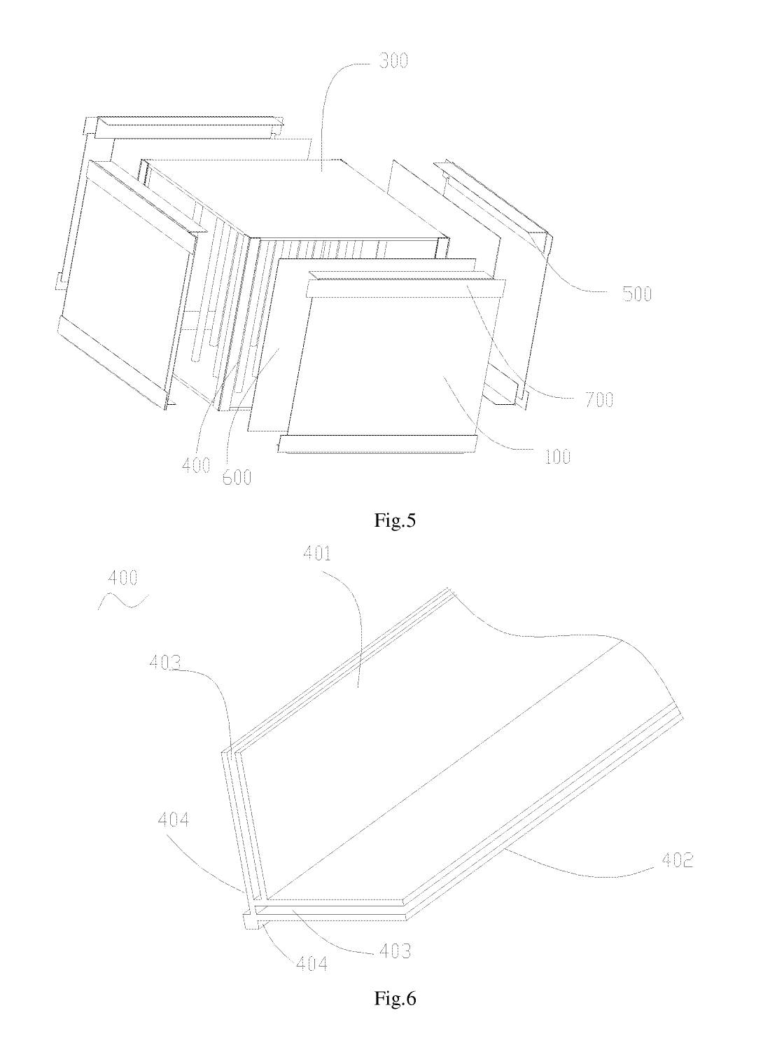

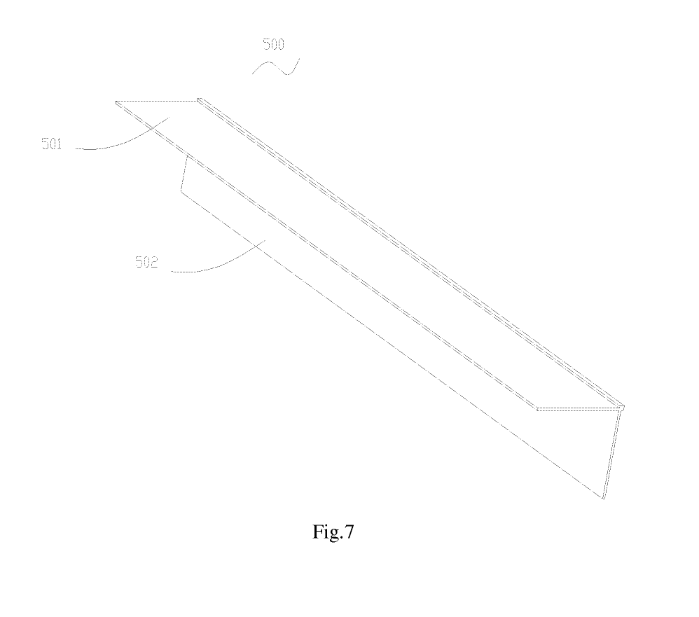

As shown in FIG. 5 to FIG. 7, the multiple display monitor according to the second embodiment in the disclosure is different from that in the first embodiment in connecting structure. In the second embodiment, each two adjacent liquid crystal display panels 100 can be connected with each other through a first fastener 400. All of the liquid crystal display panels 100 are connected with each other through a plurality of the first fasteners 400 to form the accommodating space 201. All of the liquid crystal display panels 100 are connected in such a manner that can make the multiple display monitor easily to be removed.

The first fastener 400 is of strip shape. Each first fastener 400 is connected between the edge of the first mounting plate 301 and the edge of the second mounting plate 303 vertically. The first fastener 400 comprises a first side plate 401 and a second side plate 402 connected with the first side plate vertically. The first side plate 401 may be welded to the second side plate 402. In the other embodiment, the first side plate 401 and the second side plate 402 can be made by bending a plate.

The first side plate 401 is of strip shape. A first receiving slot 403 is defined in the center of the first side plate 401 along the length thereof. The first receiving slot 403 passes through the first side plate 401 along the length thereof. A second receiving slot 404 is defined on the outer surface (remote from the backlight source device 300) of the first side plate 401 along the length thereof. The first receiving slot 403 and the second receiving slot 404 are arranged parallelly with each other.

The second side plate 401 is of strip shape. The first receiving slot 403 is defined in the center of the second side plate 402 along the length thereof. The first receiving slot 403 passes through the second side plate 402 along the length thereof. The second receiving slot 404 is defined on the outer surface (remote from the backlight source device 300) of the second side plate 402 along the length thereof.

The cross section of the first receiving slot 403 is U-shaped, which can receive things stably. The cross section of the second receiving slot 404 is L-shaped for receiving thing to be received. The second receiving slot 404 is configured for receiving the liquid crystal display panel 100. One side of the liquid crystal display panel 100 is rested against the second receiving slot 404 of the first side plate of the first fastener 400. On the other side of the liquid crystal display panel 100 is rested against the second receiving slot 404 of another first side plate of another first fastener 400 that is adjacent to the former first fastener 400. At the same time, one side of another liquid crystal display panel 100 can be rested against the second receiving slot 404 of the second side plate 402 of such fastener 400.

In order to make the multiple liquid crystal display panels 100 be connected stably, a second fastener 500 is proposed in the embodiment. In the embodiment, each liquid crystal display panel 100 is connected with the backlight source device 300 permanently through at least one second fastener 500. In specific, the second fastener 500 is formed by bending a plate. The second fastener 500 comprises a first bending portion 501 and a second bending portion 502. The first bending portion 501 and the second bending portion 502 are connected with each other vertically so that the liquid crystal display panel 100 is connected with the first mounting plate 301 or second mounting plate 303 more closely. In other embodiment, the first bending portion 501 can lie at an angle to the second portion 502. The angle is less than 90°. The first bending portion 501 is affixed to the liquid crystal display panel 100. The second bending portion 502 is affixed to the first mounting plate 301 or the second mounting plate 302 of the backlight source device 300. In other embodiments, the both ends of the liquid crystal display panel 100 can be fixed on the first mounting plate 301 and the second mounting plate 303 respectively by two second fasteners 500, so that the liquid crystal display panels 100 and the backlight source device 300 are connected with each other permanently.

An optical film 600 should be arranged on one side of the liquid crystal display panel 100 that is closed to the backlight source device 300 to diffuse the light emitted from the backlight source device 300 to form the surface light source so that each liquid crystal display panel 100 can obtain an even surface light source. The optical film 600 comprises a diffusing film, a light guide plate or the like. In this embodiment, the optical films 600 correspond to each liquid crystal display panel 100 one by one. When assembling the multiple display monitor, one side of the optical film 600 is inserted into the first receiving slot 403 of one first fastener 400, and the other side of the optical film 600 is inserted into the first receiving slot 403 of another first fastener 400 that is closed to the former first fastener 400.

A decorative strip 700 is affixed to the junction between each liquid crystal display panel 100 and the second fastener 500 to cover the junction so that the assembled multiple display monitor looks more beautiful.

Take an example to explain the multiple display monitor according to the second embodiment.

In the second embodiment, the multiple display monitor comprises four liquid crystal display panels 100 and four first fasteners 400 one of which is connected between each two adjacent liquid crystal display panels 100. Each first fastener 400 is connected between the edge of the first mounting plate 301 and the edge of the second mounting plate 302. Both sides of the optical films 600 are inserted into two first receiving slots 403 of two adjacent first fasteners 400 respectively. Both sides of the liquid crystal display panel 100 corresponding to the optical film 600 are rested against two second receiving slots 404 of two adjacent first fasteners 400. Eight-second fasteners 500 are proposed in this embodiment. The both ends of each liquid crystal display panel 100 are connected with the first mounting plate 301 and the second mounting plate 303 of the backlight source device 300 respectively through two first fasteners 500. The multiple display monitor can comprise three, five or more liquid crystal display panels 100.

It should be understood by those skilled in the art that various changes may be made and equivalents may be substituted without departing from the scope of the present invention. However, all the changes will be included within the scope of the appended claims.

1. A multiple display monitor, comprising a plurality of liquid crystal display panels that face different directions; the plurality of liquid crystal display panels surround to constitute an accommodating space for accommodating a backlight source device configured to provide a backlight to the plurality of liquid crystal display panels, the backlight source device comprises a plurality of illuminating apparatus corresponding to the liquid crystal display panels one by one in order to provide the backlight to corresponding liquid crystal display panels.

2. The multiple display monitor of claim 1, wherein the backlight source device comprises a plurality of illuminator and a first mounting plate; all of the illuminators are mounted on the first mounting plate and arranged to be the plurality of illuminating apparatus.

3. The multiple display monitor of claim 1, wherein the backlight source device further comprises a second mounting plate; the first mounting plate and the second mounting plate are arranged in parallel with each other; each illuminator is of strip shape and vertically connected between the first mounting plate and second mounting plate.

4. The multiple display monitor of claim 1, wherein the multiple display monitor further comprises a plurality of mounting parts for receiving the liquid crystal display panels one by one; the plurality of liquid crystal display panels are connected head-to-end sequentially through the corresponding mounting parts to form the accommodating space.

5. The multiple display monitor of claim 4, wherein each mounting part comprises a bottom wall and a plurality of side walls that are vertically connected with the edges of the bottom wall; the bottom wall and the plurality of side walls together form an accommodating groove for mounting the liquid crystal display panels.

6. The multiple display monitor of claim 5, wherein each liquid crystal display panel comprises a substrate, a PCB and a plurality of COFs that are connected between the substrate and the PCB; the mounting part further comprises a plurality of first arms of strip shape that are spaced from each other; all of the first arms are arranged in the accommodating groove in horizontal direction and divide the accommodating groove into a first mounting groove for receiving the substrate, a second mounting groove for receiving the PCB and a plurality of third mounting grooves for receiving the plurality of COFs.

7. The multiple display monitor of claim 5, wherein the bottom wall of the mounting part is made of polymeric methyl methacrylate or polycarbonate material.

8. The multiple display monitor of claim 1, wherein the multiple display monitor comprises a plurality of first fasteners, each two adjacent liquid crystal display panels are connected with each other through the first fastener; the plurality of liquid crystal display panels are connected with each other through the plurality of first fasteners to form the accommodating space.

9. The multiple display monitor of claim 8, wherein the first fastener comprises a first side plate and a second side plate vertically connected with the first side plate; a second receiving slot is defined on the outer surface of the first side plate along the length of the first side plate; the second receiving slot is also defined on the outer surface of the second side plate along length of the second side plate; the second side plate is configured for receiving the liquid crystal display panels.

10. The multiple display monitor of claim 9, wherein the multiple display monitor further comprises a plurality of optical films each corresponding to a liquid crystal display panel; each optical film is located on one side of the liquid crystal display panel that is adjacent to the backlight source device.

11. The multiple display monitor of claim 10, wherein a first receiving slot is defined along the length of the first side wall in the central of the first side plate; the first receiving slot is also defined along the length of the second side wall in the central of the second side plate; and the first receiving slot is configured for receiving the optical films.

12. The multiple display monitor of claim 8, wherein the multiple display monitor further comprises a plurality of second fasteners; each liquid crystal display panel is further connected with the backlight source device permanently through at least one of the second fasteners.

13. The multiple display monitor of claim 12, wherein the second fastener comprises a first bending portion of a strip shape and a second portion of a strip shape; the first bending portion and the second bending portion are formed by bending a strip plate; the first bending part is vertically connected to the second bending part.
